(19) United States
(12) Patent Application Publication
(10) Pub. No.: US 2026/0044669 A1
(43) Pub. Date: Feb. 12, 2026

(54) GENERATING CUSTOMIZED LYRIC CAPTIONS USING MACHINE LEARNING MODELS

(71) Applicant: Google LLC, Mountain View, CA (US)

(72) Inventors: Ruofei Du, San Francisco, CA (US); Hongcheng Xu, San Bruno, CA (US)

(21) Appl. No.: 19/292,743

(22) Filed: Aug. 6, 2025

Related U.S. Application Data
(60) Provisional application No. 63/680,515, filed on Aug. 7, 2024.

(51) Int. Cl. G06F 40/166; G06F 40/58

(52) U.S. Cl. CPC G06F 40/166; G06F 40/58

(57) ABSTRACT

A media stream comprising audio data and first lyric data associated with the audio data is received by a processing device. A set of user data associated with a user of a client device is identified. The first lyric data and the set of user data are provided as input to a generative machine learning model. An output of the generative machine learning model is obtained. The output comprises second lyric data. The second lyric data is a version of the first lyric data that is customized for the user. The second lyric data and the media stream are caused to be presented in a graphical user interface on the client device.

### RELATED APPLICATIONS

This application claims the benefit of priority from U.S. Provisional Patent Application No. 63/680,515, filed Aug. 7, 2024, which is incorporated herein by reference.

### TECHNICAL FIELD

Aspects and embodiments of the present disclosure relate to lyric captions for media content, and in particular to generating customized lyric captions using machine learning models.

### BACKGROUND

Media platforms can provide media content (e.g., videos, music, images) for streaming to or downloading to a client device. Media content can include video components, audio components, metadata, and other types of data. An example of metadata that can be included in media content is various types of subtitles, such as lyric captions. Lyric captions and other subtitles can provide augmented or alternative ways for users to consume media content.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some embodiments, a system and method are disclosed for generating customized lyric captions using machine learning models. In an embodiment, a method includes receiving, by a processing device, a media stream comprising audio data and first lyric data associated with the audio data. The method further includes identifying a set of user data associated with a user of a client device. The method further includes providing the first lyric data and the set of user data as input to a generative machine learning model The method further includes obtaining an output of the generative machine learning model, the output comprising second lyric data. The second lyric data is a version of the first lyric data that is customized for the user. The method further includes causing the second lyric data and the media stream to be presented in a graphical user interface (GUI) on the client device.

In an embodiment, the set of user data associated with the user of the client device comprises at least one of: a proficiency level of the user with a language associated with the first lyric data, an accessibility preference associated with the user, a user preference associated with visualization of non-lyric context, or a user preference associated with interactive lyric captions.

In an embodiment, the generative machine learning model is a large language model (LLM). Providing the set of user data as input to the generative machine learning model includes identifying a textual prompt of a plurality of textual prompts based on the set of user data and providing the textual prompt as input to the generative machine learning model.

In an embodiment, the generative machine learning model is a large multi-modal model (LMM). The method further includes providing the audio data as input to the generative machine learning model.

In an embodiment, the method further includes causing the first lyric data to be presented in the GUI on the client device. The first lyric data is to be presented in association with the second lyric data.

In an embodiment, the method further includes receiving user feedback associated with the output of the generative machine learning model. The method further includes fine-tuning the generative machine learning model based on the user feedback.

In an embodiment, the generative machine learning model is stored on the client device. An inference operation associated with the output of the generative machine learning model is performed on the client device.

In an embodiment, the second lyric data comprises an indication of an interactive lyric data element. The method further includes receiving an indication of user interaction with the interactive lyric data element. The method further includes causing informational data associated with the interactive lyric data element to be presented in the GUI on the client device.

In some embodiments a computer-readable storage medium (which can be non-transitory computer-readable storage medium, although the disclosure is not limited to that) stores instructions which, when executed, cause a processing device to perform operations comprising a method according to any embodiment or aspect described herein.

In some embodiments a system comprises: a memory; and a processing device operatively coupled with the memory to perform operations comprising a method according to any embodiment or aspect described herein.

### BRIEF DESCRIPTION OF DRAWINGS

Various embodiments in accordance with the present disclosure will be described with reference to the drawings, in which:

FIG. 1 is a block diagram of an example system architecture for a media platform that generates customized lyric captions using machine learning models, in accordance with an embodiment;

FIG. 2 depicts an example set of user data, in accordance with an embodiment;

FIG. 3 is a block diagram of an example inference engine for a media platform that generates customized lyric captions using machine learning models, in accordance with an embodiment;

FIG. 4A is an example set of inputs and outputs for a generative machine learning model that generates customized lyric captions, in accordance with an embodiment;

FIG. 4B is an example set of inputs and outputs for a generative machine learning model that generates customized lyric captions, in accordance with an embodiment;

FIG. 5 is a flow diagram of an example method for generating customized lyric captions using machine learning models, in accordance with at least one embodiment; and

FIG. 6 illustrates an example computer system, in accordance with at least one embodiment.

### DETAILED DESCRIPTION

### Introduction

Aspects of the present disclosure relate to presentation of music lyrics in media platforms. Media platforms often include captions or other textual fields for presenting lyric information associated with music, speech, or other sounds in media content provided by the media platforms. Lyric captions can be helpful to users who are hard of hearing by enabling them to understand spoken or sung text. Similarly, lyric captions can provide translations for users who do not understand the language of the spoken or sung text. Lyric captions can provide other context and benefits that enable users to connect more deeply with the media content.

The above-described media platforms can face several challenges relating to providing relevant lyric captions to users. Among these challenges are: (i) dynamic lyric caption customization based on user data, (ii) dynamic incorporation of non-lyric context in lyric captions, and (iii) identification and presentation of interactive content in lyric captions.

First, the above-described media platforms often provide uniform lyric captions for multiple users without accounting for individual user needs as indicated by user preferences or other available data. For example, a media platform can provide uniform English language lyric captions for a Japanese song for all users who enable English language subtitles in a media player of the platform. However, the media platform can fail to identify individual users' varied proficiency levels in Japanese and provide relevant lyric captions, such as mixed English and Japanese lyric captions with pronunciation guides. Such language proficiency data and other types of user preferences (e.g., accessibility preferences) can be provided by users to the media platform, but the media platform can fail to realize dynamic and personalized lyric captions based on these preferences.

Second, media platforms often fail to incorporate non-lyric context in lyric captions. For example, lyric captions can fail to communicate non-verbal auditory context such as specific instruments that are playing. In another example, lyric captions can fail to communicate an emotional sentiment associated with the media content. Some lyrics can broadly indicate some non-lyric context (e.g., a parenthetical indicating “MUSIC”), but such indicators can be coarse and can require significant manual effort by media curators to create/curate such indicators. Furthermore, media platforms can fail to use the full expressive capability of Unicode (e.g., emojis) to communicate such non-lyric context.

Third, media platforms can fail to identify opportunities to engage users with interactive content associated with media content lyrics. For example, lyrics can often include people, places, or things that a user might wish to learn more about or otherwise engage with through interactive content. As with the second challenge, some media platforms can include limited or coarse interactivity (e.g., information about the artist of a media content item), but generating such content can require significant manual effort and curation.

Aspects of the present disclosure address these challenges by generating customized lyric captions using machine learning models. An example media platform can provide one or more of the following features: (i) generation of personalized lyric captions based on large language models (LLMs), existing media content lyrics, and user preference data; (ii) generation of lyric captions for non-lyric context based on large multi-modal models (LMMs); and (iii) generation and presentation of interactive lyric captions based on LLMs and external data sources. These features are further described below.

In an embodiment, a media platform generates personalized lyric captions based on user preference data such as language preferences, accessibility preferences, lyric caption display preferences, or similar. An LLM can be trained (e.g., fine-tuned) to generate personalized lyric captions for media content based on the user preference data and existing lyrics for the media content. For example, the user preference data can be used to generate or select a prompt for the LLM, and the prompt can be provided with the existing lyric data as input to the LLM. In another example, the user preference data and existing lyric data can be directly provided as input to the LLM without a prompt. The output of the LLM can be a personalized or otherwise modified version of the existing lyric data. For example, the output can include language pronunciation guides, emojis, accessibility features, or similar. In some embodiments, the LLM is stored on a user's device, and inferencing is run on the user's device.

In an embodiment, a media platform generates lyric captions for non-lyric context of media content using an LMM. The LMM can be trained to process audio data of the media content to identify non-lyric context and generate text describing the non-lyric context. For example, the LMM can identify musical instruments in a song and generate text naming the instruments. In another example, the LMM can identify an emotional sentiment in a song and generate text describing the sentiment. Sentiments, instruments, and other non-lyric context can be expressed with words, emojis, or combinations thereof. The output of the LMM can be combined with existing lyric captions or can be provided to the LLM of the previous example media platform to further personalize the lyric captions for the non-lyric context. In some embodiments, the LMM is stored on a user's device, and inferencing is run on the user's device.

In an embodiment, a media platform generates and presents interactive lyric captions using LLMs. An LLM identifies entities (e.g., artists, places, foreign language characters, etc.) in lyric captions, which can be visually represented as clickable/tappable links in lyric captions. When a link is clicked by a user, the media platform can render an information graphical user interface clement (e.g., a popup window or sidebar) providing additional information on the associated entity. The additional information can be generated by the LLM (e.g., using retrieval augmented generation (RAG)), extracted from an information database, or similar.

Accordingly, media platforms using these techniques can provide customized lyric captions, which can enhance the user experience for users of the media platform and improve accessibility. These techniques can provide enhanced user experiences while reducing media platform resources (e.g., manual labor) needed for curating personalized lyric captions. Furthermore, some embodiments of these techniques can reduce latency experienced by users by performing LLM/LMM inferencing on user devices.

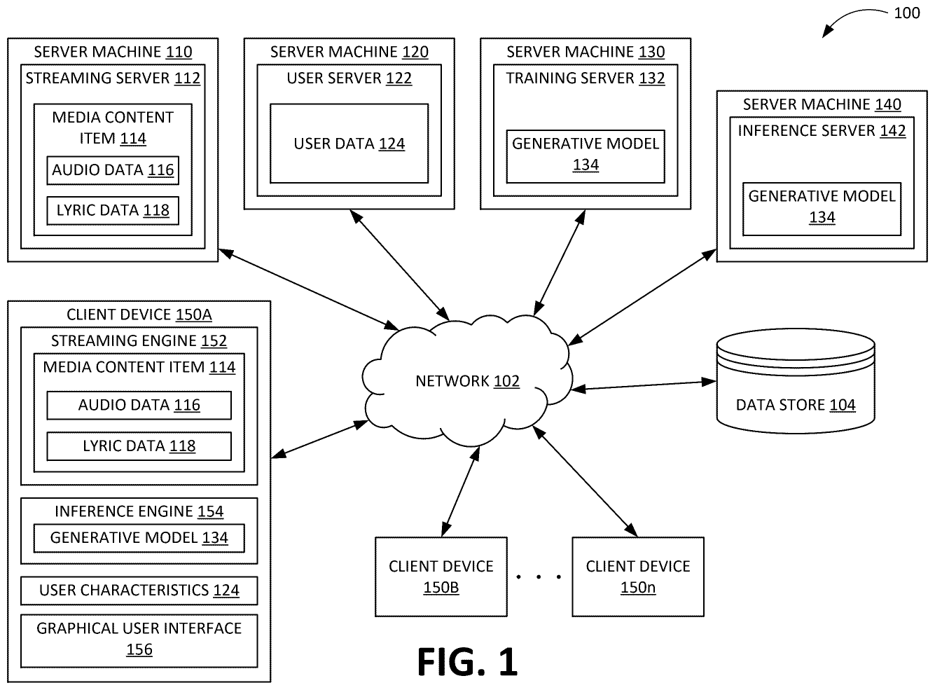

FIG. 1 is a block diagram of an example system architecture 100 for a media platform that generates customized lyric captions using machine learning models, in accordance with an embodiment. System architecture 100 (also referred to as “system” or “media platform” herein) includes network 102, data store 104, server machines 110-140, and client devices 150A-n. In various embodiments, system 100 can include more or fewer components in different configurations than those depicted in FIG. 1. For example, system 100 can include additional server machines, data stores, networks, etc.

Network 102 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. For example, network 102 can include a private enterprise network connecting data store 104 and one or more of server machines 110-140, and the private enterprise network can in turn be connected to client devices 150A-n via the Internet. In an embodiment, network 102 is a physical or virtual interconnect within a single server providing all of the components of one or more of server machines 110-140. For example, network 102 can be a PCle bus, a messaging system, or an API.

Data store 104 is a persistent storage that is capable of storing media platform content such as media content items, user profiles and preferences, machine learning models and training datasets, system configurations and settings, log data, etc. Data store 104 can be hosted by one or more storage devices, such as main memory, magnetic or optical storage-based disks, tapes or hard drives, NAS, SAN, and so forth. In an embodiment, data store 104 is a network-attached file server. In various embodiments, data store 104 is some other type of persistent storage such as an object-oriented database, a relational database, and so forth. In various embodiments, data store 104 is hosted on or is a component of one or more of server machines 110-140. In an embodiment, data store 104 is provided by a third-party service such as a cloud platform provider.

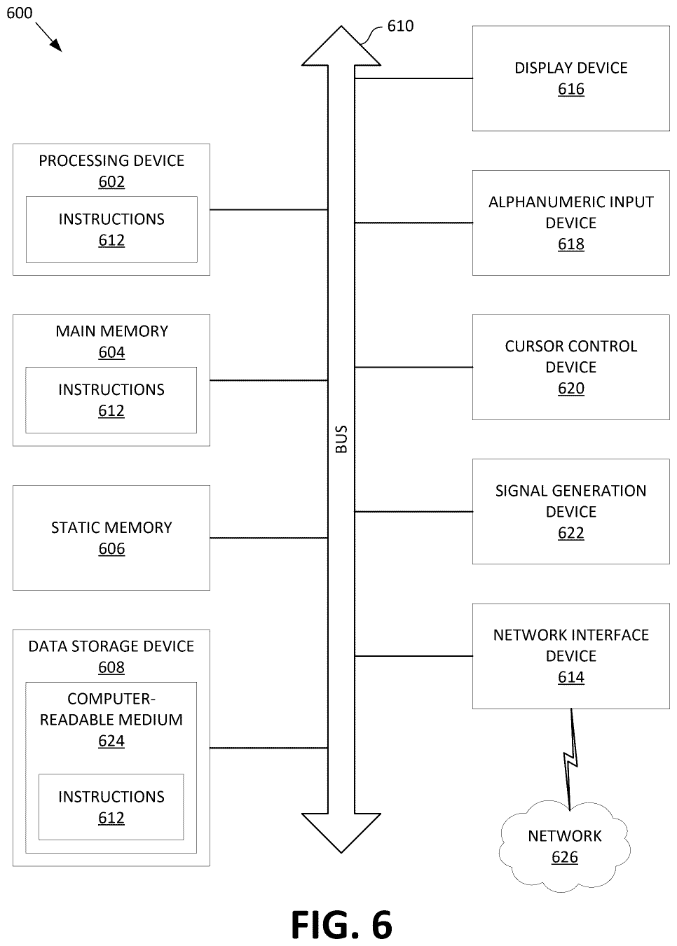

Each of server machines 110-140 can be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server machine. In various embodiments, one or more of server machines 110-140 can be combined into a single server machine providing all of the components of the individual server machines depicted in FIG. 1. In various embodiments, each of server machines 110-140 can be several computing devices, such as multiple rackmount servers in a data center(s) or multiple VMs in a cloud platform.

Server machine 110 includes streaming server 112, which can provide streaming functions for the media platform. Streaming functions can include receiving client requests to initiate media streams or to stream a media content item, querying media content metadata, determining types of media content and selecting media content items to stream, obtaining media content items from local or remote storage (e.g., data store 104), adding DRM protections to media streams, and various other activities. Streaming server 112 can manage multiple active media streams for multiple clients. In an embodiment, a single media stream managed by streaming server 112 is associated with multiple clients (e.g., a live TV broadcast program).

Streaming server 112 can include one or more media content items such as media content item 114. Media content item 114 can be a video-on-demand content item, a live TV program, a music track, a slideshow (e.g., of images), or other type of media content item. Media content item 114 can be consumed via the Internet or via a mobile device application, such as streaming engine 152 described below with reference to client device 150A. In an embodiment, media content item 114 corresponds to a media file (e.g., a video file, an audio file, a video stream, an audio stream, etc.). In other or similar embodiments, media content item 114 corresponds to a portion of a media file (e.g., a portion or a chunk of a video file, an audio file, etc.). As used herein, “media,” “media item,” “multimedia item,” “online media item,” “digital media,” “digital media item,” “content,” “multimedia content,” and “content item” can include an electronic file that can be executed or loaded using software, firmware or hardware configured to present the digital media item to an entity. Streaming server 112 can store media content item 114, or a reference to media content item 114, using data store 104, in an embodiment. In another embodiment, streaming server 112 can store media content item 114 or a fingerprint as an electronic file in one or more formats (e.g., H.264/AVC, VP9, H.265/HEVC, AV1, ACC, MP3) using data store 104. Streaming server 112 can provide media content item 114 to a user associated with one of client devices 150A-n by allowing access to media content item 114 (e.g., via a streaming platform application), transmitting the media content item 114 to the client device, and/or presenting or permitting presentation of the media content item 114 via the client device.

In an embodiment, media content item 114 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional, and three-dimensional video. Further, video items can include movies, video clips, video streams, or any set of images (e.g., animated images, non-animated images, etc.) to be displayed in sequence. In an embodiment, a video item can be stored (e.g., at data store 104) as a video file that includes a video component and an audio component (e.g., audio data 116). The video component can include video data that corresponds to one or more sequential video frames of the video item. The audio component can include audio data that corresponds to the video data.

In an embodiment, media content item 114 can be associated with metadata. Metadata can include title, author, channel, captions, comments from other users, lyrics (e.g., lyric data 118), etc. related to media content item 114. Metadata can also include timeline-related information, such as a current playback position, most-watched or most-interesting time ranges, etc.

In an embodiment, lyric data 118 corresponds to audio data 116. Audio data 116 can include linguistic audio data. For example, audio data 116 can include spoken or sung words in one or more languages, such as song lyrics or dialogue. Audio data 116 can further include non-linguistic audio data such as instrumental music, natural or non-natural sounds, etc. Other types of information can be conveyed in audio data 116, such as sentiment (e.g., via vocal tone, music key, etc.). Lyric data 118 can include a textual form of the spoken or sung words or a version thereof, such as a translation in one or more languages different than the spoken/sung language.

A media platform such as system 100 can include multiple channels (e.g., channels A through Z). A channel can include one or more media content items 114 available from a common source or media content items 114 having a common topic, theme, or substance. Media content items 114 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” can also be referred to as “liking,” “following,” “friending,” and so on.

In some embodiments, system 100 can include one or more third-party platforms (not shown). In some embodiments, a third-party platform can provide other services associated with media content items 114. For example, a third-party platform can include an advertisement platform that can provide video and/or audio advertisements. In another example, a third-party platform can be a video streaming service provider that produces a media streaming service via a communication application for users to play videos, TV shows, video clips, audio, audio clips, and movies, on client devices 150A-n via the third-party platform.

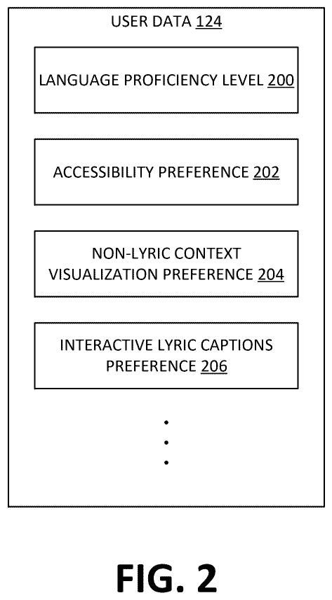

Server machine 120 includes user server 122, which can store user data (e.g., user data 124) associated with one or more users. User data 124 are further described below with reference to FIG. 2. User data 124 can be determined, set, and/or stored in whole or in part at client device 150A and/or at user server 122 in various embodiments.

Server machine 130 includes training server 132, which can train a generative machine learning model such as generative model 134. Server machine 140 includes inference server 142, which can perform inference for generative model 134. A generative machine learning model such as generative model 134 learns how the input training data is generated and can generate new data (e.g., original data). A generative machine learning model can model the probability distribution (e.g., joint probability distribution) of a dataset and generate new samples that often resemble the training data. Generative machine learning models can be used for tasks involving image generation, text generation and/or data synthesis. Generative machine learning models include, but are not limited to, gaussian mixture models (GMMs), variational autoencoders (VAEs), generative adversarial networks (GANs), large language models (LLMs), visual language models (VLMs), multi-modal models (e.g., text, images, video, audio, depth, physiological signals, etc.), and so forth.

In an embodiment, generative model 134 is a GAN. A GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In an embodiment, generative model 134 can be a generative large language model (LLM). In some embodiments, generative model 134 can be a large language model that has been pre-trained on a large corpus of data so as to process, analyze, and generate human-like text based on given input. Generative model 134 can have different LLM architectures in various embodiments, including one or more architectures as seen in Generative Pre-trained Transformer (GPT) series (Chat GPT series LLMs), Google's Bard®, or LaMDA, or leverage a combination of transformer architecture with pre-trained data to create coherent and contextually relevant text.

In an embodiment, generative model 134 uses an encoder-decoder architecture including one or more self-attention mechanisms, and one or more feed-forward mechanisms. In an embodiment, generative model 134 includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data.

Generative model 134 can also utilize other deep learning techniques, including recurrent neural networks (RNNs), convolutional neural networks (CNNs), or transformer networks.

In an embodiment, generative model 134 is a multi-modal generative machine learning model, such as a Visual-Language Model (VLM) or large multi-modal model (LMM). In an embodiment, generative model 134 is a VLM that has been pre-trained on a large corpus of data (e.g., textual data and image data) so as to process, analyze, and generate human-like text and/or image data based on given input (e.g., image data and/or natural language text).

In an embodiment, training generative model 134 at training server 132 includes providing training input to generative model 134, and generative model 134 can produce one or more training outputs. The one or more training inputs can be compared to one or more evaluation metrics. An evaluation metric can refer to a measure used to assess the output (e.g., training output(s)) of a machine learning model, such as generative model 134. In an embodiment, the evaluation metric is specific to the task and/or goals of generative model 134. Based on the comparison, one or more parameters and/or weights of generative model 134 can be adjusted (e.g., backpropagation based on computed loss). For example, the one or more training outputs can be compared to an evaluation metric such as a ground truth (e.g., target output, such as a correct or better answer). In another example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In an embodiment, generative model 134 is trained on a corpus of data, such textual data and/or image data. In an embodiment, generative model 134 is a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative machine learning model. The foundational model can first be pre-trained using a corpus of data (e.g., text and/or images) that can include text and/or image content in the public domain, licensed content, and/or proprietary content (e.g., proprietary organizational data). Generative model 134 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that generative model 134 is to be adapted (e.g., generating lyric captions). In an embodiment, generative model 134 is or includes one or more pre-trained models or fine-tuned models.

During inference (e.g., in inference server 142), a prompt can be provided to generative model 134 to produce an output (e.g., text output, image output, video output, etc.). A prompt can refer to an input (e.g., a specific input) or instruction provided to generative model 134 to generate a response. In an embodiment, a prompt can be written, at least in part, in natural language. Natural language can refer a language that is expressed in or corresponds to a way that humans communicate using spoken or written language to convey meaning, express thoughts, and/or interact. In an embodiment, the prompt specifies the information or context that generative model 134 can use to produce an output. For example, a prompt can include text, image, or other data that serves as the starting point for generative model 134 to perform a task. In various embodiments, generative model 134 can be stored in a server, in a client device, or in a combination thereof. In various embodiments, inference of generative model 134 can be performed by a server, by a client device, or by a combination thereof.

Client devices 150A-n can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 150A-n can also be referred to as “user devices.” Client devices 150A-n can run an operating system (OS) that manages hardware and software of client devices 150A-n. Client devices 150A-n can further include a web browser, application, or other software for streaming media content. Client devices 150A-n can be used by users such as viewers of a media platform. In general, and as described below, functions described in embodiments as being performed by a media platform and/or server machines 110-140 can also or alternatively be performed on client devices 150A-n in other embodiments. In addition, the functionality attributed to a particular component can be performed by different or multiple components operating together.

Client device 150A (and/or, e.g., client devices 150B-n) includes streaming engine 152, which can provide streaming functions for client device 150A. Streaming functions can include sending client requests to initiate media streams, querying media content metadata, determining types of media content and selecting media content items to stream, receiving media content items from streaming servers (e.g., streaming server 112), decoding DRM protections of media streams, presenting media content (e.g., via graphical user interface 156), and various other activities. For example, streaming engine 152 can receive, decode, present, etc. media content item 114 and associated audio data 116 and lyric data 118 described previously.

Client device 150A (and/or, e.g., client devices 150B-n) includes inference engine 154, which can perform local inference for generative model 134 (e.g., as described with reference to inference server 142). In an embodiment, client device 150A receives generative model 134 (which can be pre-trained or fine-tuned as previously described) from training server 132 or other component of system 100. In an embodiment, generative model 134 is customized (e.g., fine-tuned based on user data) for client device 150A or a user thereof, and client devices 150B-n can include different generative models 134 with different customizations.

Client device 150A (and/or, e.g., client devices 150B-n) includes user data 124, previously described with reference to user server 122 and subsequently with reference to FIG. 2. User data 124 can be determined, set, and/or stored in whole or in part at client device 150A and/or at user server 122 in various embodiments.

Client device 150A (and/or, e.g., client devices 150B-n) includes graphical user interface (GUI) 156, which can present media content item 114 to a user of client device 150A. GUI 156 can include a media player, which can depict image or video data. The media player can further drive one or more speakers to play audio data. GUI 156 can further depict lyric captions and other subtitles.

In an embodiment, a “user” of a client device can be represented as a single individual. However, other embodiments encompass a “user” being an entity controlled by a set of users and/or an automated source. For example, a set of individual users federated as a community in a social network can be considered a “user.” In another example, an automated consumer can be an automated ingestion pipeline of a media platform.

Further to the descriptions above, a user can be provided with controls allowing the user to make an election as to both if and when systems, programs, or features described herein can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 depicts an example set of user data 124, in accordance with an embodiment. In various embodiments, user data 124 can include more, fewer, or different user data than those depicted in FIG. 2. As described with reference to FIG. 1, user data can be stored in a server or client device associated with a media platform. For example, user data 124 can be set and/or stored in a global preferences application of client devices 150A-n. In another example, user data 124 can be derived from other user data, such as a user's most frequently used language.

Language proficiency level 200 indicates a user's proficiency level in reading, writing, speaking, and/or understanding one or more natural languages. In an embodiment, language proficiency level 200 is an indicator of a preferred or primary language. For example, language proficiency level 200 can indicate a user's native language or a user's preferred language for subtitles and lyric captions. In an embodiment, language proficiency level 200 is a binary indicator of language proficiency. For example, language proficiency level 200 can indicate “yes” or “no” to whether a user speaks each of one or more languages. In an embodiment, language proficiency level 200 is a multi-valued or continuous indicator of language proficiency. For example, language proficiency level 200 can indicate a user's degree of comfort or proficiency with each of one or more languages. Such indications can be subjective (e.g., self-evaluated) or objective (e.g., corresponding to language proficiency test results).

Accessibility preference 202 indicates one or more accessibility preferences set for a user. In an embodiment, accessibility preference 202 indicates one or more sensory accessibility preferences, such as screen brightness and colors, text size, audio volume, presence/absence of subtitles, or similar. In an embodiment, accessibility preference 202 indicates one or more cognitive accessibility preferences, such as user age, vocabulary preferences, or similar.

Non-lyric context visualization preference 204 indicates one or more user preferences for presentation of non-lyric (e.g., non-textual) context in lyric captions. For example, non-lyric context visualization preference 204 can indicate whether a user wants emotional sentiment or musical instrumentation to be depicted in lyric captions.

Interactive lyric captions preference 206 indicates one or more user preferences for interactive experience associated with lyric captions. For example, interactive lyric captions preference 206 can indicate whether a user wants biographical or historical information about artists, bands, lyrics, etc. to be retrieved and linked to lyric captions such that the information is presented when the user taps or clicks on the relevant lyric captions.

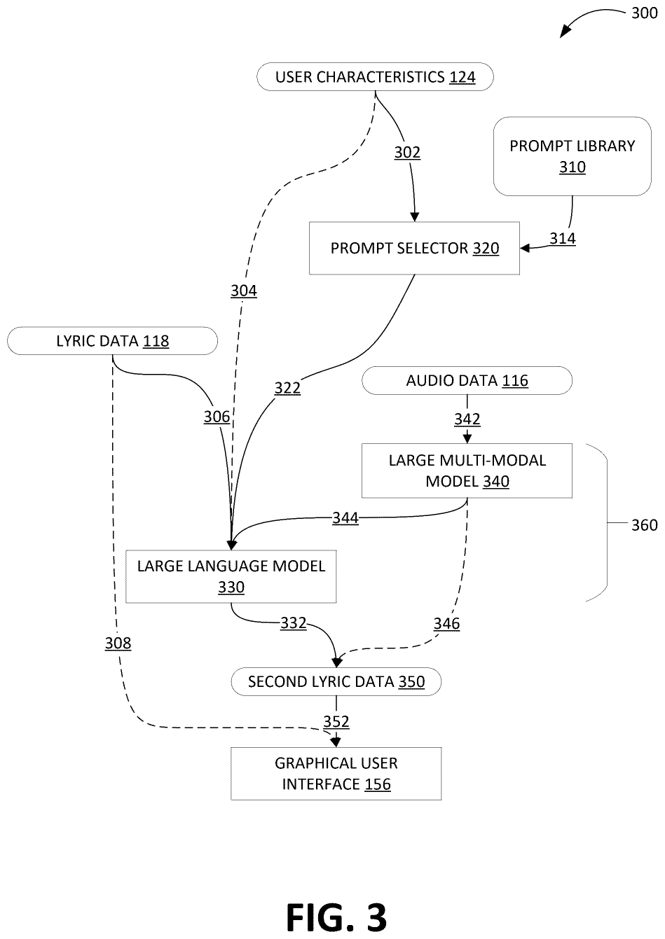

FIG. 3 is a block diagram of an example inference engine 300 for a media platform that generates customized lyric captions using machine learning models, in accordance with an embodiment. Inference engine 300 can correspond to inference server 142 or inference engine 154 in various embodiments. Inference engine 300 includes prompt library 310, prompt selector 320, LLM 330, and LMM 340. Inputs to inference engine 300 can include audio data 116, lyric data 118, and one or more user data 124. Outputs of inference engine 300 can include second lyric data 350, which can be presented on GUI 156 of FIG. 1 in an embodiment. In various embodiments, more, fewer, or different components can be included in inference engine 300.

Prompt library 310 can include one or more textual prompts that can be used to prompt an LLM (e.g., LLM 330) to generate customized lyric captions. Different prompts can be designed to generate different customized lyric captions. For example, one prompt can instruct the LLM to generate pronunciation guides for foreign language lyrics based on a user's proficiency level, while another prompt can instruct the LLM to generate simplified lyrics for younger audiences (e.g., children). Various prompts can be associated with the types of user data described with reference to FIG. 2. Prompts of prompt library 310 can be manually or automatically generated (e.g., as part of a training process). Prompts of prompt library 310 can be static or can be changed based on user feedback associated with outputs of the LLM. Prompt selector 320 can select a relevant LLM prompt of prompt library 310 (e.g., obtained via data path 314) based on provided user data 124 (e.g., obtained via data path 302).

Inference engine 300 can include one or more generative machine learning models. In an embodiment, LLM 330 corresponds to generative model 134 of FIG. 1. In an embodiment, LMM 340 corresponds to generative model 134 of FIG. 1. In an embodiment, LLM 330 and LMM 340 are component models of conglomerate generative machine learning model 360. For example, model 360 can be a mixture-of-experts model or similar conglomerate model. Model 360 can correspond to generative model 134 of FIG. 1.

Lyric data 118 can be provided (e.g., via data path 306) as input to LLM 330 (or model 360). User data can similarly be provided as input to LLM 330, either directly (e.g., via data path 304), or via prompt selection (e.g., via data path 322). Lyric data 118 can be combined with user data 124 or a selected prompt to create the full input prompt for LLM 330. After running inference on LLM 330, the output can form all or part of second lyric data 350 (e.g., via data path 332), which can be a customized version of lyric data 118.

Audio data 116 can be provided (e.g., via data path 342) as input to LMM 340 to generate non-lyric context from audio data. For example, LMM 340 can identify musical instrumentation of a song or emotional sentiment based on musical key or tone of voice. After running inference on LMM 340, the output can be a textual output describing the identified instrumentation, emotional sentiment, etc. The output can form all or part of second lyric data 350 (e.g., via data path 346), or can be provided to LLM 330 (e.g., via data path 344) as an additional or alternative input to generate the customized version of lyric data 118.

In an embodiment, second lyric data 350 can be presented on GUI 156 (e.g., via data path 352) in place of lyric data 118. For example, second lyric data 350 can be a translation of or a simplified version of lyric data 118 and thus can replace lyric data 118 on GUI 156. In an embodiment, second lyric data 350 can be presented on GUI 156 in association with lyric data 118 (e.g., via data paths 308 and 352). For example, second lyric data 350 can be a pronunciation guide or music/sentiment analysis that augments, rather than replacing, lyric data 118.

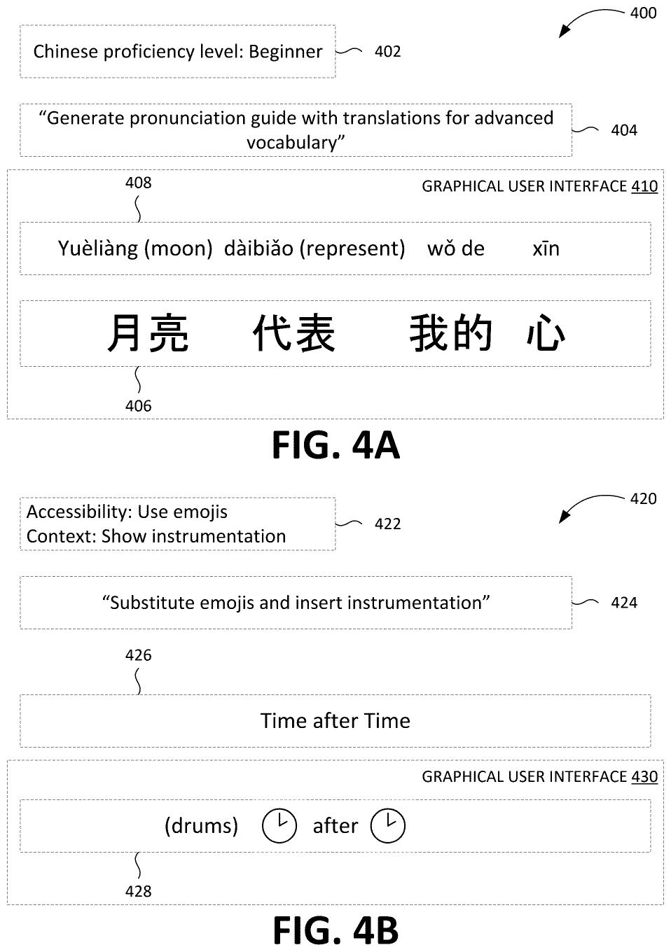

FIG. 4A is an example set 400 of inputs and outputs for a generative machine learning model that generates customized lyric captions, in accordance with an embodiment. Set 400 includes user data input 402, prompt input 404, lyric data input 406, and lyric data output 408. User data input 402 can correspond to user data 124, prompt input 404 can correspond to a prompt of prompt library 310 selected by prompt selector 320, lyric data input 406 can correspond to lyric data 118, and lyric data output 408 can correspond to second lyric data 350.

As depicted in example set 400, a user's proficiency in a foreign language can be used to determine a set of pronunciation guides to accompany the foreign language lyrics. User data input 402 indicates that the user has a beginner level of proficiency in Chinese. User data input 402 can be used to select or generate prompt input 404 that instructs a generative model to generate a pronunciation guide with translations for advanced vocabulary. One or both of inputs 402 and 404 can be provided along with lyric data input 406 (Chinese characters) to generate the full input prompt for the generative model. The generative model can then generate lyric data output 408 with Chinese pinyin pronunciation and English translations for advanced vocabulary. Lyric data input 406 and lyric data output 408 can be presented together in graphical user interface 410 along with the relevant media content item.

FIG. 4B is an example set 420 of inputs and outputs for a generative machine learning model that generates customized lyric captions, in accordance with an embodiment. Set 420 includes user data input 422, prompt input 424, lyric data input 426, and lyric data output 428. User data input 422 can correspond to user data 124, prompt input 424 can correspond to a prompt of prompt library 310 selected by prompt selector 320, lyric data input 426 can correspond to lyric data 118, and lyric data output 428 can correspond to second lyric data 350.

As depicted in example set 420, a user's accessibility and non-lyric context preferences can be used to determine a customized version of input lyrics to replace the original input lyrics. User data input 422 indicates that the user prefers to substitute emojis where possible, as well as show musical instrumentation. User data input 422 can be used to select or generate prompt input 424 that instructs a generative model to substitute emojis and insert instrumentation. One or both of inputs 422 and 424 can be provided along with lyric data input 426 (plain lyrics) to generate the full input prompt for the generative model. The generative model can then generate lyric data output 428 with emoji substitutions and instrumentation indicators. As described with reference to FIG. 2, an LMM can be used to determine the musical instrumentation, which can then be provided as an additional input to a LLM for generating lyric data output 428. Lyric data output 428 can be presented in place of lyric data input 426 in graphical user interface 430 along with the relevant media content item.

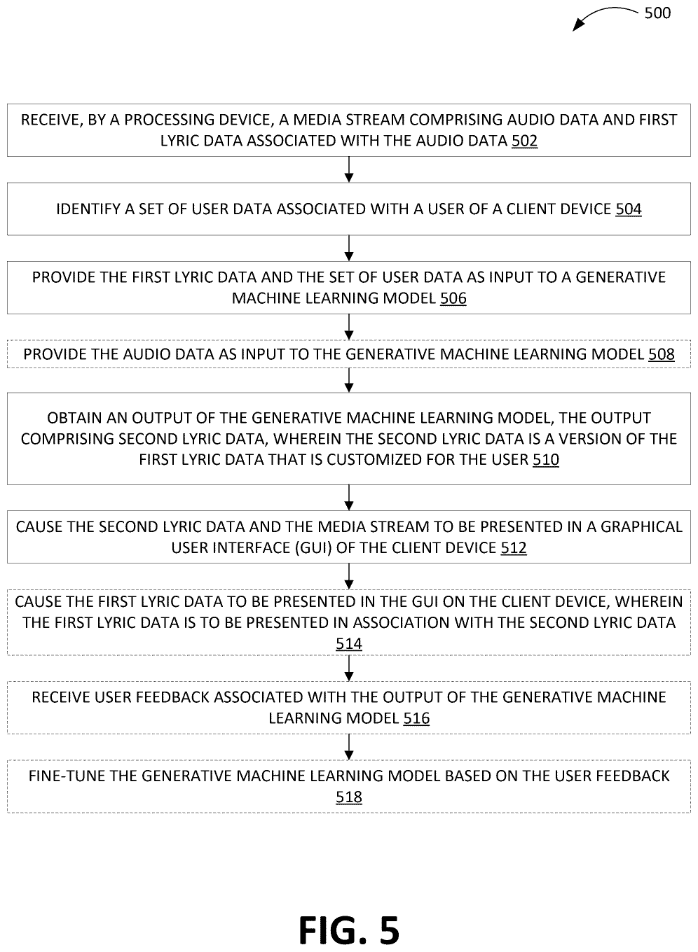

FIG. 5 is a flow diagram of an example method 500 for generating customized lyric captions using machine learning models, in accordance with at least one embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 500. Method 500 can also be associated with a set of instructions stored on a non-transitory computer-readable medium (e.g., magnetic or optical disk, etc.). The instructions, when executed by a processing device, can cause the processing device to perform operations comprising the blocks of method 500. In at least one embodiment, method 500 is performed by one or more of server machines 110-140 or client devices 150A-n of FIG. 1, or components thereof. In at least one embodiment, method 500 is performed by computing system 600 of FIG. 6. In some embodiments, blocks depicted in FIG. 5 could be performed simultaneously or in a different order than depicted. Various embodiments can include additional blocks not depicted in FIG. 5 or a subset of blocks depicted in FIG. 5. For example, blocks depicted with a dashed outline (e.g., blocks 508 and 514-518) can be absent in an embodiment.

At block 502, processing logic receives a media stream comprising audio data and first lyric data associated with the audio data. In an embodiment, the media stream corresponds to media content item 114, the audio data corresponds to audio data 116, and the first lyric data corresponds to lyric data 118. The media stream can be received at client device 150A (e.g., via streaming engine 152) from a media platform (e.g., from streaming server 112). The first lyric data can be a transcript or translation of spoken/sung text of the audio data. The audio data can include additional non-textual information such as instrumental music, emotional sentiment, or similar.

At block 504, the processing logic identifies a set of user data associated with a user of a client device. The set of user data can correspond to one of user data 124. For example, the set of user data can include at least one of a proficiency level of the user with a language associated with the first lyric data, an accessibility preference associated with the user, a user preference associated with visualization of non-lyric context, or a user preference associated with interactive lyric captions as previously described with reference to FIG. 2.

At block 506, the processing logic provides the first lyric data and the set of user data as input to a generative machine learning model. The generative machine learning model can be generative model 134 of FIG. 1 and can be an LLM (e.g., LLM 330), LMM (e.g., LMM 340), or other type of generative model. As previously described, the generative model can be pre-trained or fine-tuned, and can be customized for specific users or can be shared between multiple users. In an embodiment, the first lyric data and the set of user data are provided to the generative model as one or more prompts (e.g., data paths 304-306 of FIG. 3).

In an embodiment, providing the set of user data as input to the generative machine learning model comprises identifying a textual prompt of a plurality of textual prompts based on the set of user data, and providing the textual prompt as input to the generative machine learning model. For example, the set of user data can be provided to the generative model via a prompt selector (e.g., prompt selector 320), which can select a relevant prompt (e.g., from prompt library 310) to supply to the generative model based on the set of user data.

In an embodiment, the generative machine learning model is stored on the client device, and an inference operation associated with an output of the generative machine learning model (e.g., the output of block 510) is performed on the client device. In an embodiment, the inference operation is performed on a server of the media platform.

At block 508, the processing logic provides the audio data as input to the generative machine learning model. In an embodiment, the generative machine learning model of block 508 is the same generative model of block 506. In an embodiment, the generative machine learning model of block 508 is a different generative machine learning model than the generative model of block 506. For example, the model of block 506 can be an LLM, while the model of block 508 can be an LMM. In an embodiment, the two generative machine learning models are component models of a larger generative machine learning model, such as a mixture-of-experts architecture or similar. For example, the audio data can be provided as input to an LMM component model, and the output of the LMM component model can be provided as input to an LLM component model (e.g., data path 344 of FIG. 3).

At block 510, the processing logic obtains an output of the generative machine learning model, the output comprising second lyric data, wherein the second lyric data is a version of the first lyric data that is customized for the user (e.g., customized to reflect the set of user data). For example, the first lyric data can be customized based on language, accessibility, or other preferences indicated by the user. The second lyric data can include a translation of the first lyric data, a simplification of the first lyric data, additional context for the first lyric data, or similar.

At block 512, the processing logic causes the second lyric data and the media stream to be presented in a graphical user interface (GUI) of the client device. The GUI can be GUI 156 of FIG. 1. The media stream can be presented in a media viewer, with audio data played by speakers of the client device. The second lyric data can be presented adjacent to or overlapping with (e.g., on top of) the media viewer.

In an embodiment, the second lyric data comprises an indication of an interactive lyric data element, such as a hyperlink or an interactive GUI element. The processing logic can receive an indication of user interaction with the interactive lyric data element (e.g., a click or tap) and cause informational data associated with the interactive lyric data element to be presented in the GUI on the client device. For example, a pop-up GUI element providing biographical or historical context for a lyric phrase can be presented in response to the user tapping or clicking on the lyric phrase.

At block 514, the processing logic causes the first lyric data to be presented in the GUI on the client device, wherein the first lyric data is to be presented in association with the second lyric data. In an embodiment, the first lyric data can be presented above or below the second lyric data. For example, the first lyric data can be song lyrics in the same language as the song, and the second lyric data can be pronunciation guides in the user's native language and can be positioned above or below the song lyrics.

At block 516, the processing logic receives user feedback associated with the output of the generative machine learning model. For example, the user feedback can be a rating (e.g., good/bad, ranking on a scale of 1-5) of the quality or relevance of the output of the generative machine learning model based on the user's expectations. In another example, the user feedback can be indirect or passive feedback, such whether or for how long the user continues to engage with the model output or the media platform as a whole.

At block 518, the processing logic fine-tunes the generative machine learning model based on the user feedback. For example, the processing logic can use reinforcement learning with human feedback (RLHF) or similar techniques to fine-tune the generative machine learning model based on the user feedback.

FIG. 6 is a block diagram illustrating an example computer system 600, in accordance with embodiments of the present disclosure. Computer system 600 can correspond to server machines 110-140 or client devices 150A-n, as described with reference to FIG. 1. Computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for generating customized lyric captions using machine learning models) for performing the operations discussed herein.

Computer system 600 can further include network interface device 614. Computer system 600 also can include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 can include a non-transitory machine-readable storage medium 624 (also computer-readable storage medium) on which is stored one or more sets of instructions 612 (e.g., for generating customized lyric captions using machine learning models) embodying any one or more of the methodologies or functions described herein. Instructions 612 can also reside, completely or at least partially, within main memory 604 or within the processing device 602 during execution thereof by computer system 600, main memory 604 and processing device 602 also constituting machine-readable storage media. Instructions 612 can further be transmitted or received over network 626 via network interface device 614.

In one implementation, instructions 612 include instructions for generating customized lyric captions using machine learning models, as described herein. While computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, by a processing device, a media stream comprising audio data and first lyric data associated with the audio data;
identifying a set of user data associated with a user of a client device;
providing the first lyric data and the set of user data as input to a generative machine learning model;
obtaining an output of the generative machine learning model, the output comprising second lyric data, wherein the second lyric data is a version of the first lyric data that is customized for the user; and
causing the second lyric data and the media stream to be presented in a graphical user interface (GUI) on the client device.

2. The method of claim 1, wherein the set of user data associated with the user of the client device comprises at least one of:
a proficiency level of the user with a language associated with the first lyric data;
an accessibility preference associated with the user;
a user preference associated with visualization of non-lyric context; or
a user preference associated with interactive lyric captions.

3. The method of claim 1, wherein the generative machine learning model is a large language model (LLM), and wherein providing the set of user data as input to the generative machine learning model comprises:
identifying a textual prompt of a plurality of textual prompts based on the set of user data; and
providing the textual prompt as input to the generative machine learning model.

4. The method of claim 1, wherein the generative machine learning model is a large multi-modal model (LMM), and wherein the method further comprises:
providing the audio data as input to the generative machine learning model.

5. The method of claim 1, further comprising:
causing the first lyric data to be presented in the GUI on the client device, wherein the first lyric data is to be presented in association with the second lyric data.

6. The method of claim 1, further comprising:
receiving user feedback associated with the output of the generative machine learning model; and
fine-tuning the generative machine learning model based on the user feedback.

7. The method of claim 1, wherein the generative machine learning model is stored on the client device, and wherein an inference operation associated with the output of the generative machine learning model is performed on the client device.

8. The method of claim 1, wherein the second lyric data comprises an indication of an interactive lyric data element, and wherein the method further comprises:
receiving an indication of user interaction with the interactive lyric data element; and
causing informational data associated with the interactive lyric data element to be presented in the GUI on the client device.

9. A system comprising:
a memory device; and
a processing device coupled to the memory device, the processing device to perform operations comprising:
receiving a media stream comprising audio data and first lyric data associated with the audio data;
identifying a set of user data associated with a user of a client device;
providing the first lyric data and the set of user data as input to a generative machine learning model;
obtaining an output of the generative machine learning model, the output comprising second lyric data, wherein the second lyric data is a version of the first lyric data that is customized for the user; and
causing the second lyric data and the media stream to be presented in a graphical user interface (GUI) on the client device.

10. The system of claim 9, wherein the set of user data associated with the user of the client device comprises at least one of:
a proficiency level of the user with a language associated with the first lyric data;
an accessibility preference associated with the user;
a user preference associated with visualization of non-lyric context; or
a user preference associated with interactive lyric captions.

11. The system of claim 9, wherein the generative machine learning model is a large language model (LLM), and wherein providing the set of user data as input to the generative machine learning model comprises:
identifying a textual prompt of a plurality of textual prompts based on the set of user data; and
providing the textual prompt as input to the generative machine learning model.

12. The system of claim 9, wherein the generative machine learning model is a large multi-modal model (LMM), and wherein the operations further comprise:
providing the audio data as input to the generative machine learning model.

13. The system of claim 9, the operations further comprising:
causing the first lyric data to be presented in the GUI on the client device, wherein the first lyric data is to be presented in association with the second lyric data.

14. The system of claim 9, the operations further comprising:
receiving user feedback associated with the output of the generative machine learning model; and
fine-tuning the generative machine learning model based on the user feedback.

15. A non-transitory computer-readable medium comprising instructions that, when executed by a processing device, cause the processing device to perform operations comprising:
receiving a media stream comprising audio data and first lyric data associated with the audio data;
identifying a set of user data associated with a user of a client device;
providing the first lyric data and the set of user data as input to a generative machine learning model;
obtaining an output of the generative machine learning model, the output comprising second lyric data, wherein the second lyric data is a version of the first lyric data that is customized for the user; and
causing the second lyric data and the media stream to be presented in a graphical user interface (GUI) on the client device.

16. The non-transitory computer-readable medium of claim 15, wherein the set of user data associated with the user of the client device comprises at least one of:
a proficiency level of the user with a language associated with the first lyric data;
an accessibility preference associated with the user;
a user preference associated with visualization of non-lyric context; or
a user preference associated with interactive lyric captions.

17. The non-transitory computer-readable medium of claim 15, wherein the generative machine learning model is a large language model (LLM), and wherein providing the set of user data as input to the generative machine learning model comprises:
identifying a textual prompt of a plurality of textual prompts based on the set of user data; and
providing the textual prompt as input to the generative machine learning model.

18. The non-transitory computer-readable medium of claim 15, wherein the generative machine learning model is a large multi-modal model (LMM), and wherein the operations further comprise:
providing the audio data as input to the generative machine learning model.

19. The non-transitory computer-readable medium of claim 15, wherein the generative machine learning model is stored on the client device, and wherein an inference operation associated with the output of the generative machine learning model is performed on the client device.

20. The non-transitory computer-readable medium of claim 15, wherein the second lyric data comprises an indication of an interactive lyric data element, and wherein the operations further comprise:
receiving an indication of user interaction with the interactive lyric data element; and
causing informational data associated with the interactive lyric data element to be presented in the GUI on the client device.
